(19) United States
(12) Patent Application Publication
(10) Pub. No.: US 2017/0362429 A1
(43) Pub. Date: Dec. 21, 2017

(54) WHITE POLYESTER FILM AND METHOD FOR MANUFACTURING SAME, SOLAR CELL BACK SHEET, AND SOLAR CELL MODULE

(71) Applicant: FUJIFILM CORPORATION, Tokyo (JP)

(72) Inventor: Takeaki SAWAYA, Shizuoka (JP)

(21) Appl. No.: 15/697,457

(22) Filed: Sep. 7, 2017

Related U.S. Application Data
(63) Continuation of application No. PCT/JP2016/058019, filed on Mar. 14, 2016.

(30) Foreign Application Priority Data
Mar. 31, 2015 (JP) 2015-074352

(51) Int. Cl. C08L 67/08; B29C 47/14; B29C 55/02; C08J 5/18; C08J 3/22; B29C 47/16

(52) U.S. Cl. CPC C08L 67/08; C08J 5/18; C08J 3/22; B29C 47/145; B29C 55/02; B29C 47/16

(57) ABSTRACT

Provided are a white polyester film including a polyester and white particles having an average primary particle diameter of 0.20 to 0.40 μm, in which a content of the white particles is 1.0% to 5.0% by mass with respect to the total mass of the film, a ratio of agglomerated particles having particle diameters of 0.40 to 0.80 μm in a direction parallel to a surface direction of the film on the cross-section of the film to the total number of primary particles and agglomerated particles of the white particles dispersed in the film is 10% to 20% by number, and a concentration of terminal carboxyl groups is 6 to 30 equivalents/ton, a method for manufacturing the same, a solar cell back sheet, and a solar cell module.

### CROSS-REFERENCE TO RELATED APPLICATION

This application is a Continuation of International Application No. PCT/JP2016/058019, filed Mar. 14, 2016, which claims priority to Japanese Patent Application No. 2015-074352, filed Mar. 31, 2015. Each of the above applications is hereby expressly incorporated by reference, in its entirety, into the present application.

### BACKGROUND OF THE INVENTION

### 1. Field of the Invention

The present invention relates to a white polyester film and a method for manufacturing the same, a solar cell back sheet, and a solar cell module.

### 2. Description of the Related Art

Recently, solar cells have been attracting attention as next-generation sustainable energy sources.

Solar cell modules are constituted of members such as a solar cell element, a sealing material that surrounds (seals) the solar cell element, a transparent front substrate disposed on a light-receiving surface side of the solar cell element, and a rear surface protective sheet for a solar cell (also referred to as “solar cell back sheet” or “back sheet”) that protects a side opposite to the light-receiving surface side (rear surface side).

Solar cell modules are used outdoors for a long period of time, and thus the constituent members thereof are required to have weather resistance, that is, durability in natural environments.

In addition, for the distribution of solar cells, the improvement of power generation efficiencies is important. Examples of the method for improving the power generation efficiencies of solar cell modules include, in addition to a method for improving the incident photon-to-current conversion efficiencies of solar cell elements, a method in which light rays having wavelengths in the visible light range which contribute to power generation are reflected on the solar cell back sheet and the amount of light rays incident on the solar cell element is increased, a method in which light rays having wavelengths in the near-infrared region are reflected and heat accumulation in solar cells is prevented, and the like.

Meanwhile, typical examples of base materials that are used for solar cell back sheets include fluorine-based films, polyethylene-based films, and polyester-based films.

Particularly, polyester-based films are inexpensive and have excellent characteristics and are thus widely used as the base material for solar cell back sheets. Among these, in order to increase the reflectivity of light rays having wavelengths in the visible light range and the near-infrared range and increase the power generation efficiency of solar cells, white polyester films into which white particles are kneaded are proposed.

JP2011-258879A describes that the reflectivity in both the visible light range and the near-infrared range is improved and thus the power generation efficiency of a solar cell module is improved by adding two kinds of titanium oxide, that is, titanium oxide A having an average particle diameter of 0.15 μm or more and 0.35 μm or less and titanium oxide B having an average long axis length of 0.7 to 6 μm and an average short axial length of 0.2 to 1.5 μm to the rear surface protective sheet (back sheet) of the solar cell module.

WO2013/005822A describes that the reflectivity in the visible light through near-infrared range is improved by adding 5% to 70% by mass of at least one of an inorganic filler or an organic filler having an average particle diameter of 0.05 to 0.9 μm to a solar cell back sheet, forming pores using the filler as a nuclei, and setting the porosity to 55% or less.

### SUMMARY OF THE INVENTION

In order to improve the power generation efficiencies of solar cells, it is effective to use white polyester films having a reflectivity of light rays having wavelengths in the near-infrared range and the infrared range increased by kneading white particles thereinto as solar cell back sheets. Regarding the particle diameters of the white particles that are kneaded into polyester films, since the scattering power becomes strong at particle diameters that are approximately half the wavelengths according to Mie's light scattering theory, it is effective to use white particles having particles diameters of 0.20 to 0.40 μm for the reflection in the visible light range and 0.40 to 1.00 μm for the reflection in the near-infrared range.

Meanwhile, in steps of kneading white particles into polyesters, hydrolyses caused by moisture in the white particles and thermal decomposition caused by heat generated by the shearing of the white particles occur. As the particle diameters of white particles increase, shear heating becomes more significant, and thus, in a case in which white particles having relatively large particle diameters are used in order to improve the reflectivity in the near-infrared range, the molecular weights of polyesters are decreased due to thermal decomposition, and consequently, hydrolysis resistance degrades.

For the solar cell back sheet disclosed by JP2011-258879A, in the step of kneading titanium oxide B having large particles diameters in which the average long axis length is 0.7 to 6 μm and the average short axial length is 0.2 to 1.5 μm into the back sheet, resins are easily decomposed, and the hydrolysis resistance degrades.

In addition, in the solar cell back sheet disclosed by WO2013/005822A, when the back sheet is installed outdoors, the pores formed in the back sheet serve as a hotbed for accumulating moisture, and hydrolysis is caused from the pores as the starting points, and thus the pores cause the degradation of hydrolysis resistance.

That is, the addition of white particles to polyester films in order to improve the reflectivity in the visible light range and the near-infrared range has a trade-off relationship with the improvement of hydrolysis resistance. For the above-described reason, it is difficult to satisfy both an increase in the reflectivity of light rays having wavelengths in both the visible light range and the near-infrared range and hydrolysis resistance in order to improve the power generation efficiencies of solar cells.

The present invention has been made in consideration of the above-described circumstances, and an object of the present disclosure is to provide a white polyester film having excellent hydrolysis resistance and an excellent reflectivity of light rays in the visible light range and the near-infrared range, a method for manufacturing the same, a solar cell back sheet, and a solar cell module capable of maintaining a high power generation efficiency for a long period of time outdoors.

Specific means for achieving the above-described object is as described below.

<1> A white polyester film comprising: a polyester; and white particles having an average primary particle diameter of 0.20 to 0.40 μm, in which a content of the white particles is 1.0% to 5.0% by mass with respect to the total mass of the film, when a cross-section of the film in a thickness direction is observed, a ratio of agglomerated particles having particle diameters of 0.40 to 0.80 μm in a direction parallel to a surface direction of the film on the cross-section of the film to the total number of primary particles and agglomerated particles of the white particles dispersed in the film is 10% to 20% by number, and a concentration of terminal carboxyl groups is 6 to 30 equivalents/ton.

<2> The white polyester film according to <1>, in which a thickness thereof is 280 to 500 μm.

<3> A method for manufacturing the white polyester film according to <1> or <2>, in which a polyester A and a polyester B in which an intrinsic viscosity IV_{A} of the polyester A and an intrinsic viscosity IV_{B} of the polyester B satisfy Expressions (I) and (II) are used, the method comprising: a master batch preparation step of preparing a master batch including the polyester A and 40% to 60% by mass of white particles having an average primary particle diameter of 0.20 to 0.40 μm; an extrusion step of forming a non-stretched film by supplying the master batch and the polyester B to an extruder and melting and extruding a molten resin on a cooling roll while controlling the number of rotations N per minute of a screw in the extruder, an extrusion amount Q of the molten resin from an outlet of the extruder per hour, and an inner diameter D of a cylinder in the extruder to satisfy Expression (III); and a stretching step of stretching the non-stretched film in at least one direction,

IV_{A}+0.12<IV_{B} (I)

IV_{B}>0.74 (II)

3.0×10⁻⁶×D^{2.8}<Q/N<9.0×10⁻⁶×D^{2.8} (III)
a unit of N is min⁻¹, a unit of Q is kg/h, a unit of D is mm, and units of IV_{A} and IV_{B} are all dL/g.

<4> The method for manufacturing a white polyester film according to <3>, in which, in the extrusion step, the master batch and the polyester B are supplied to the extruder using mutually different suppliers, and the polyester B is supplied to the extruder by imparting a fluctuation of ±1.0% to ±5.0% of an average supply amount per unit time of supply amounts of the polyester B.

<5> The method for manufacturing a white polyester film according to <3> or <4>, in which, in the extrusion step, the polyester B is supplied to the extruder in a supply amount of 500 to 5,000 kg/h.

<6> A solar cell back sheet comprising: the white polyester film according to <1> or <2>.

<7> A solar cell module comprising: a solar cell element; a sealing material that seals the solar cell element; a front substrate disposed on an outside of the sealing material on a light-receiving surface side of the solar cell element; and the solar cell back sheet according to <6> disposed on an outside of the sealing material on a side opposite to the light-receiving surface side of the solar cell element.

According to the present invention, a white polyester film having excellent hydrolysis resistance and an excellent reflectivity of light rays in the visible light range and the near-infrared range, a method for manufacturing the same, a solar cell back sheet, and a solar cell module capable of maintaining a high power generation efficiency for a long period of time outdoors are provided.

### BRIEF DESCRIPTION OF THE DRAWINGS

FIG. 1 is a schematic view illustrating white particles dispersed in a film on a cross-section of the film in a thickness direction.

### DESCRIPTION OF THE PREFERRED EMBODIMENTS

Hereinafter, embodiments of the present invention will be described, and the following embodiments are simply examples of the present invention and do not limit the present invention.

Meanwhile, in the present specification, numerical ranges expressed using “to” refer to ranges including the numerical values before and after the “to” as the upper limit value and the lower limit value. In addition, in a case in which a unit is given only to the upper limit value of a numerical range, the lower limit value also has the same unit as the upper limit value.

As a result of intensive studies in consideration of the above-described object, the present inventors found that, in polyester films containing white particles, in a case in which the content of the white particles, the particle diameters of the primary particles of the white particles, the particle diameters and ratios of agglomerated particles, and the concentration of terminal carboxyl groups respectively satisfy predetermined conditions, the above-described object is achieved, and it is possible to satisfy both the improvement of hydrolysis resistance and the improvement of the reflectivity of light rays in the visible light range and the near-infrared range. The present invention was completed on the basis of this finding.

<White Polyester Film>

A white polyester film of the present disclosure (hereinafter, in some cases, referred to as “polyester film” or “film”) includes a polyester and white particles having an average primary particle diameter of 0.20 to 0.40 μm, the content of the white particles is 1.0% to 5.0% by mass with respect to the total mass of the film, when a cross-section of the film in a thickness direction is observed, the ratio of agglomerated particles having particle diameters of 0.40 to 0.80 μm in a direction parallel to a surface direction of the film on the cross-section of the film (hereinafter, in some cases, referred to as “the particle diameters in the film surface direction” or simply as “particle diameters”) to the total number of primary particles and agglomerated particles of the white particles dispersed in the film is 10% to 20% by number, and the concentration of terminal carboxyl groups is 6 to 30 equivalents/ton.

The white particles having an average primary particle diameter of 0.20 to 0.40 μm which are included in the white polyester film of the present disclosure are dispersed and present in a primary particle or agglomerated particle form in the film. Here, the primary particles refer to a state in which the white particles are not in contact with any other white particles and are singly present in the film, and the agglomerated particles refer to a state in which primary particles come into contact with other primary particles in the film and thus two or more primary particles form one particle.

According to Mie's light scattering theory, the scattering power becomes strong at particle diameters that are approximately half the wavelengths. The white polyester film of the present disclosure includes white particles having an average primary particle diameter of 0.20 to 0.40 μm and is thus capable of effectively reflecting light rays in the visible light range (for example, wavelengths: 400 to 800 nm).

Meanwhile, 10% to 20% by mass of the total number of the primary particles and agglomerated particles of the white particles dispersed in the white polyester film of the present disclosure are agglomerated particles having particle diameters in the film surface direction of 0.40 to 0.80 μm. The presence of these agglomerated particles enables the effective reflection of, particularly, light rays in the near-infrared range (for example, wavelength: 800 to 2,000 nm). In addition, these agglomerated particles are formed due to the agglomeration of white particles having primary particle diameters of 0.20 to 0.40 mainly in an extrusion step in the case of manufacturing the white polyester film of the present disclosure, and thus shear heating is suppressed compared with a case in which white particles having primary particle diameters of 0.40 to 0.80 μm are used. Therefore, it is considered that a decrease in the molecular weight of the polyester due to thermal decomposition is suppressed, and consequently, highly hydrolysis-resistant polyester films can be obtained.

(Polyester)

The polyester included in the white polyester film of the present disclosure is not particularly limited, and examples thereof include linear saturated polyesters synthesized from an aromatic dibasic acid or an ester-forming derivative thereof and a diol or an ester-forming derivative thereof.

Specific examples thereof include polyethylene terephthalate (PET), polyethylene isophthalate, polybutylene terephthalate (PBT), poly(1,4-cyclohexylene dimethylene terephthalate), polyethylene-2,6-naphthalate (PEN), and the like. Among these, polyethylene terephthalate and polyethylene-2,6-naphthalate are preferred, and polyethylene terephthalate is particularly preferred in terms of the balance between mechanical properties and costs.

The polyester included in the white polyester film of the present disclosure may be a homopolymer or a copolymer. Furthermore, the white polyester film of the present disclosure may include a resin obtained by blending a small amount of a different resin, for example, polyimide or the like to the polyester as a resin component.

(White Particles)

The white polyester film of the present disclosure includes 1.0 to 5.0% by mass of white particles having an average primary particle diameter of 0.20 to 0.40 μm with respect to the total mass of the film, and the ratio of agglomerated particles having particle diameters of 0.40 to 0.80 μm to the total number of the primary particles and agglomerated particles of the white particles dispersed in the film is 10% to 20% by number.

The white particles included in the white polyester film of the present disclosure may be any of inorganic particles or organic particles, or both particles may be jointly used.

As the inorganic particles, it is possible to use, for example, wet silica, dry silica, colloidal silica, calcium carbonate, aluminum silicate, calcium phosphate, alumina, magnesium carbonate, zinc carbonate, titanium oxide, zinc oxide (also referred to as zinc flower), antimony oxide, cerium oxide, zirconium oxide, tin oxide, lanthanum oxide, magnesium oxide, barium carbonate, zinc carbonate, basic lead carbonate (also referred to as lead white), barium sulfate, calcium sulfate, lead sulfate, zinc sulfate, mica, titanated mica, talc, clay, kaolin, lithium fluoride, calcium fluoride, and the like.

In addition, the surfaces of the white particles may be treated with an inorganic material such as alumina or silica or may be treated with an organic material such as a silicon-based material or an alcohol-based material.

Among these white particles, titanium dioxide and barium sulfate are preferred, and titanium dioxide particles are particularly preferred. In the case of including titanium dioxide particles, the white polyester film of the present disclosure is capable of exhibiting excellent durability even under light irradiation.

As titanium dioxide, there are rutile-type titanium dioxide and anatase-type titanium dioxide, and the white polyester film of the present disclosure preferably includes titanium dioxide particles which mainly include rutile-type titanium dioxide. “Mainly” mentioned herein indicates that the amount of the rutile-type titanium dioxide in all of the titanium dioxide particles exceeds 50% by mass.

Light rays in the ultraviolet range barely contribute to the power generation of solar cells, and thus the ultraviolet spectral reflectivity of the white particles is desirably high from the viewpoint of preventing the deterioration of the polyester by ultraviolet rays. Rutile-type titanium dioxide has an extremely high ultraviolet spectral reflectivity, but anatase-type titanium dioxide has a characteristic of a high ultraviolet absorbance (a low spectral reflectivity). Due to the difference in the above-described spectral characteristic attributed to the crystal format of titanium dioxide, the use of the ultraviolet absorption performance of rutile-type titanium dioxide enables the improvement of light resistance in, for example, polyester films for protecting solar cell rear surfaces (solar cell back sheets). In addition, in a case in which the ultraviolet absorption performance of rutile-type titanium dioxide is used, film durability under light irradiation is excellent even without the substantial addition of other ultraviolet absorbents. Therefore, contamination and the degradation of adhesiveness caused by the bleed-out of ultraviolet absorbents are not easily caused.

The content of anatase-type titanium dioxide in the titanium dioxide particles included in the white polyester film of the present disclosure is preferably 10% by mass or less, more preferably 5% by mass or less, and particularly preferably 0% by mass. In a case in which the content of anatase-type titanium dioxide in the titanium dioxide particles included in the white polyester film of the present disclosure is 10% by mass or less, the amount of rutile-type titanium dioxide in all of the titanium dioxide particles relatively increases, and thus the ultraviolet absorption performance becomes sufficient, and additionally, it is possible to suppress the degradation of light resistance caused by the strong photocatalytic action of the anatase-type titanium dioxide. Rutile-type titanium dioxide and anatase-type titanium dioxide can be differentiated from each other by X-ray structural diffraction or spectral absorption characteristics.

The surfaces of the rutile-type titanium dioxide particles may be treated with an inorganic material such as alumina or silica or may be treated with an organic material such as a silicon-based material or an alcohol-based material.

Before the rutile-type titanium dioxide particles are blended into the polyester, the adjustment of particle diameters and the removal of coarse particles may be carried out using purification processes. Regarding industrial means for the purification processes, for example, jet milling and ball milling can be applied as crushing means, and, for example, dry-type or wet-type centrifugal separation can be applied as classification means.

The white polyester film of the present disclosure may contain organic particles as the white particles. The organic particles are preferably particles capable of withstanding heat during the formation of the polyester film, and, for example, white particles made of a crosslinking-type resin can be used. Specifically, polystyrene crosslinked with divinylbenzene and the like can be used.

(Content of White Particles)

The content of the white particles in the white polyester film of the present disclosure is 1.0% by mass or more and 5.0% by mass or less and preferably 2.0% by mass or more and 4.5% by mass or less with respect to the total mass of the film.

In a case in which the content of the white particles in the polyester film is below 1.0% by mass, the weather resistance is excellent, but a sufficient reflectivity can be obtained in both the visible light range and the near-infrared range. In a case in which the content of the white particles exceeds 5.0% by mass, the reflectivity is excellent in both the visible light range and the near-infrared range, but the hydrolysis resistance degrades, and it is not possible to obtain films satisfying both the hydrolysis resistance and the reflectivity in the visible light range and the near-infrared range. In a case in which the content of the white particles in the entire film is set in a range of 1.0% to 5.0% by mass and preferably 2.0% to 4.5% by mass, it is possible to satisfy both the hydrolysis resistance and the reflectivity in the visible light range and the near-infrared range in a well-balanced manner.

The content of the white particles included in the white polyester film can be measured using the following method.

3 g of the film is placed in a crucible as a measurement specimen and is heated at 900° C. for 120 minutes in an electric oven. After that, the crucible is removed while cooling the measurement specimen in the electric oven, and the mass of ash remaining in the crucible is measured. This ash is the component of the white particles, and a value obtained by dividing the mass of the ash by the mass of the measurement specimen and multiplying the result by 100 is used as the content (% by mass) of the white particles.

(Particle Diameters of White Particles)

The average primary particle diameter of the white particles in the white polyester film of the present disclosure is 0.20 to 0.40 μm and preferably 0.20 to 0.30 μm.

Since the scattering power of the white particles becomes strong at wavelengths that are approximately twice the particle diameters according to Mie's light scattering theory, in a case in which the particle diameters of the white particles are below 0.20 μm, the reflectivity at wavelengths of 400 to 800 nm, which is the visible light range, decreases. On the other hand, in a case in which the primary particle diameters of the white particles exceed 0.40 μm, in steps of kneading the white particles to the polyester, the generation of heat caused by shearing among the white particles becomes significant, and the thermal decomposition of the polyester is accelerated, and consequently, the hydrolysis resistance degrades. The white polyester film of the present disclosure is manufactured using the white particles having an average primary particle diameter of 0.20 to 0.40 μm, and thus the generation of heat caused by shearing amount the white particles is suppressed at a low level, and it is possible to suppress the degradation of the hydrolysis resistance caused by the thermal decomposition of the polyester.

For the white particles in the white polyester film of the present disclosure, the particle distribution of the primary particles preferably has one peak in a range of 0.20 to 0.40 μm. In a case in which the particle distribution of the primary particles has one peak in a range of 0.20 to 0.40 μm, the generation of heat caused by shearing among the white particles becoming significant in steps of kneading the white particles into the polyester is effectively suppressed, and the degradation of the hydrolysis resistance caused by the thermal decomposition of the polyester is suppressed. In addition, in a case in which the particle distribution has one peak, it is easy to control the particle diameters of the white particles in the film to preferred ranges and to obtain a sufficient reflectivity in the near-infrared range.

Some of the white particles in the white polyester film of the present disclosure agglomerate together and are present in an agglomerated particle form, and the ratio of agglomerated particles having particle diameters in the film surface direction of 0.40 to 0.80 μm to the total number of the primary particles and agglomerated particles of the white particles dispersed in the film is 10% to 20% by number. Particles having particle diameters in the film surface direction of 0.40 to 0.80 μm contribute to the reflection of, particularly, light rays in the near-infrared range, and, in a case in which the ratio is 10% by number or more, it is possible to obtain a sufficient reflectivity in the near-infrared range. On the other hand, in a case in which the ratio of the agglomerated particles having particle diameters in the film surface direction of 0.40 to 0.80 μm is 20% by number or less, the number of 0.20 to 0.40 μm white particles (primary particles) which do not agglomerate and contribute to the reflection of light rays in the visible light range is also relatively great, and it is possible to obtain a sufficient reflectivity in the visible light range.

The ratio of the agglomerated particles having particle diameters in the film surface direction of 0.40 to 0.80 μm is preferably 14% to 16% by number from the viewpoint of the balance among the hydrolysis resistance, the reflectivity in the visible light range, and the reflectivity in the near-infrared range.

For the observation of the particle diameters of the white particles dispersed in the film, a scanning electron microscope is used. A torn surface which is along the stretching direction (first direction) of the film and perpendicular to the film surface (a cross-section of the film in the thickness direction) and a torn surface which is along a direction perpendicular to the first direction in the film surface (second direction) and perpendicular to the film surface (a cross-section of the film in the thickness direction) are observed in ten different portions of a sample, thereby obtaining observation images of a total of 20 places. Observation is carried out at an appropriate magnification of 100 to 10,000 times, and photographs are captured so that the dispersion state of the white particles can be confirmed in the width of the entire thickness of the film.

For example, in the case of a biaxial stretched film, one of the machine stretching direction (transportation direction) and the transverse stretching direction is considered as the first direction, and, in the case of a monoaxial stretched film, the stretched direction is considered as the first direction, and cross-sections (film cross-sections) of the film in the thickness direction may be respectively observed along the first direction and the second direction.

In addition, in the case of a film roll, cross-sections of the film in the thickness direction may be respectively observed along the circumferential direction (transportation direction) and the width direction of the roll. In addition, for example, in the case of a rectangular film cut along the circumferential direction and the width direction of the roll, film cross-sections may be observed along directions that are respectively parallel to two sides forming the right angle.

Meanwhile, the agglomerated particles in the film of the present disclosure are oriented in the stretching direction, and thus, regardless of the shape of the film after cutting, the direction in which the agglomerated particles are oriented is considered as the first direction, and film cross-sections may be respectively observed along the first direction and the second direction.

Furthermore, in a case in which the stretching direction of the film or the direction in which the agglomerated particles are oriented in the film is not clear, arbitrary two directions that are orthogonal to each other in the film surface are considered as the first direction and the second direction, and film cross-sections may be respectively observed.

Regarding the average primary particle diameter of the white particles, the outer circumferences of at least 200 primary particles randomly selected from the obtained photograph are traced, the lengths of the primary particles in a direction parallel to the film surface are measured from the traced images using an image analyzer, and these lengths are defined as the primary particle diameters. As the average primary particle diameter of the white particles, a value obtained by arithmetically averaging the values of at least 200 measured primary particle diameters is used.

Meanwhile, in the case of before the manufacturing of the film, for at least 200 primary particles randomly selected from the white particles (white pigment) that is used as a raw material, the average primary particle diameter may be obtained by carrying out observation in the same manner as described above and arithmetically averaging the primary particle diameters.

Meanwhile, the ratio of the number of the agglomerated particles having particle diameters in the film surface direction of 0.40 to 0.80 μm, the outer circumferences of at least 200 primary particles (primary particles and agglomerated particles) randomly selected from the obtained photograph are traced, the lengths of the primary particles in a direction parallel to the film surface are measured from the traced images using an image analyzer, and these lengths are defined as the particle diameters in the film surface direction.

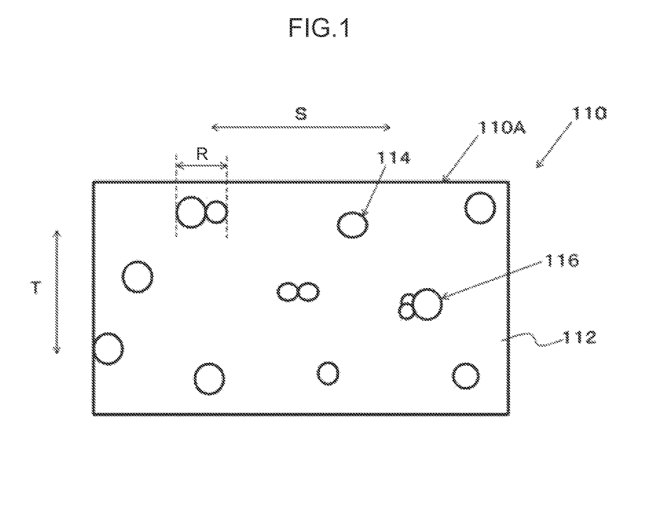

FIG. 1 schematically illustrates an example of white particles dispersed in a film on a cross-section of a white polyester film 110 of the present disclosure in a thickness direction T. White particles are respectively present in a state of being dispersed as primary particles 114 or agglomerated particles 116 in a polyester 112. For example, the particle diameter R of the agglomerated particle 116 in the film surface direction corresponds to the length between both end portions of the agglomerate particle 116 in a direction S parallel to a film surface 110A (film surface direction) in the cross-section of the film 110.

In a case in which the white particles dispersed in the film are present in a primary particle form, each primary particle is counted as one white particle, and, in a case in which the white particles are present in an agglomerated particle form, each agglomerated particle is counted as one white particle, and the ratio of the number of the agglomerated particles having a particle diameter in the film surface direction of 0.40 to 0.80 μm to at least 200 measured particles is expressed by a percentage (% by number).

From the viewpoint of obtaining a sufficient reflectivity in the visible light range, the ratio of white particles which do not agglomerate, are present in a primary particle form, and have primary particle diameters of 0.20 to 0.40 μm to the total number of the primary particles and agglomerated particles of the white particle in the white polyester film of the present disclosure is preferably 80% by number or more and more preferably 84% by number or more.

In addition, from the viewpoint of obtaining a reflectivity in the near-infrared range, the ratio of the agglomerated particles having particle diameters of 0.40 to 0.80 μm to the total number of the primary particles and agglomerated particles of the white particles in the white polyester film of the present disclosure is preferably 10% by number or more and 20% by number or less and more preferably 14% by number or more and 16% by number or less.

Meanwhile, the white polyester film of the present disclosure may include white particles having primary particle diameters of less than 0.20 μm; however, in the case of being present in a primary particle form, the white particles having primary particle diameters of less than 0.20 μm barely contribute to the improvement of the reflectivity. Therefore, the ratio of the white particles having primary particle diameters of less than 0.20 μm to the total number of the primary particles and agglomerated particles of the white particle in the white polyester film of the present disclosure is preferably 3% by number or less and more preferably 1.5% by number or less.

In a case in which the white polyester film of the present disclosure includes coarse agglomerated particles having particle diameters of more than 0.8 μm which are formed due to the agglomeration of the white particles, fracture is likely to occur from the coarse particles as the starting points, and the hydrolysis resistance degrades. Therefore, the white polyester film preferably does not substantially include agglomerated particles having particle diameters of more than 0.8 μm.

In addition, out of the total number of the primary particles and agglomerated particles of the white particles dispersed in the white polyester film of the present disclosure, almost all particles having particle diameters in the surface direction of the film (film surface direction) of 0.40 to 0.80 μm are agglomerated particles which are formed due to the agglomeration of two or more primary particles of the white particles, but the white polyester film may also include white particles having primary particle diameters of more than 0.40 μm. However, in a case in which the white particles having primary particle diameters of more than 0.40 μm are present in a primary particle form, the white particles contribute to the reflection of light rays in the near-infrared range; however, as the ratio of white particles having great primary particle diameters increases, there is a tendency that the temperature during melting and kneading increases and the polyester easily decomposes. Therefore, the ratio of the white particles having primary particle diameters of more than 0.40 μm is preferably 2% by number or less and more preferably 1% by number or less.

(Concentration of Terminal Carboxyl Groups)

In the white polyester film of the present disclosure, the concentration of terminal carboxyl groups is preferably 6 to 30 equivalents/ton. In order to improve the weather resistance of the film, the amount of the terminal carboxyl groups (also referred to as the concentration of the terminal carboxyl groups; the acid value and is expressed as “AV” in some cases) is set in a certain range, whereby the hydrolysis resistance improves. Meanwhile, in the present specification, “equivalents/ton” represents the molar equivalents per ton and is expressed as “eq/t” in some cases.

In a case in which the concentration of the terminal carboxyl groups in the polyester film is less than 6 equivalents/ton, the number of carboxyl groups (COOH groups) on the surface becomes too small (that is, the polarity becomes too low), and the adhesiveness to different kinds of materials such as other resin layers degrades. On the other hand, in a case in which the concentration of the terminal carboxyl groups in the polyester film is more than 30 equivalents/ton, the hydrolysis resistance degrades. This is because H⁺ in the COOH groups at the polyester molecular terminals acts as a catalyst and accelerates hydrolysis.

The concentration of the terminal carboxyl groups is a value measured using the following method. That is, 0.1 g of a measurement sample is dissolved in 10 ml of benzyl alcohol, furthermore, chloroform is added thereto so as to obtain a solution mixture, and a phenol red indicator is added dropwise to the solution mixture. This solution is titrated with a reference liquid (0.01 mol/L KOH-benzyl alcohol solution mixture), and the concentration of the terminal carboxyl groups is obtained from the titration amount.

From the viewpoint of improving the adhesiveness to different kinds of materials and improving the hydrolysis resistance, the concentration of the terminal carboxyl groups in the white polyester film of the present disclosure is preferably 8 to 25 equivalents/ton and more preferably 10 to 20 equivalents/ton.

(Thickness)

The thickness of the white polyester film of the present disclosure is preferably 280 to 500 μm and more preferably 280 to 350 μm. In a case in which the thickness is set to 280 μm or more, the reflectivity improves in both the visible light range and the near-infrared range, and, in a case in which the thickness is set to 500 μm or less, the productivity improves, and it is possible to reduce the costs.

(Terminal Sealant)

The white polyester film of the present disclosure may be a film having hydrolysis resistance (weather resistance) improved by adding a terminal sealant thereto.

The content of the terminal sealant which may be included in the white polyester film of the present disclosure is 0.1% to 10% by mass with respect to the total mass of the polyester. The amount of the terminal sealant added is more preferably 0.2% to 5% by mass and still more preferably 0.3% to 2% by mass with respect to the total mass of the polyester included in the polyester film.

Since the hydrolysis of the polyester is accelerated by the catalytic effect of H⁺ generated from the carboxyl groups and the like at molecular terminals, it is effective to add a terminal sealant that reacts with the terminal carboxyl groups in order to improve the hydrolysis resistance (weather resistance).

In a case in which the amount of the terminal sealant added is 0.1% by mass or more with respect to the total mass of the polyester, a weather resistance-improving effect is easily developed, and, in a case in which the amount added is 10% by mass or less, the terminal sealant acting as a plasticizer on the polyester is suppressed, and the degradation of dynamic strength and heat resistance is suppressed.

Examples of the terminal sealant include epoxy compounds, carbodiimide compounds, oxazoline compounds, carbonate compounds, and the like, and carbodiimide having a high affinity to polyethylene terephthalate (PET) and a favorable terminal sealing capability are preferred.

The terminal sealant (particularly, the carbodiimide terminal sealant) preferably has a high molecular weight. In such a case, it is possible to reduce sublimation during the formation of films by means of melting. The molecular weight of the terminal sealant is preferably 200 to 100,000, more preferably 2,000 to 80,000, and still more preferably 10,000 to 50,000. In a case in which the molecular weight of the terminal sealant (particularly, the carbodiimide terminal sealant) is in a range of 200 to 100,000, the terminal sealant is easily uniformly dispersed in the polyester, and it becomes easy to sufficiently develop the weather resistance-improving effect. In addition, the terminal sealant is not easily extruded and does not easily sublime during the formation of films, and it becomes easy to develop the weather resistance-improving effect.

Meanwhile, the molecular weight of the terminal sealant refers to the weight-average molecular weight.

Carbodiimide-Based Terminal Sealant:

As carbodiimide compounds having a carbodiimide group, there are monofunctional carbodiimides and multifunctional carbodiimide, and examples of the monofunctional carbodiimides include dicyclohexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide, di-β-naphtylcarbodiimide, and the like. Dicyclohexylcarbodiimide and diisopropylcarbodiimide are particularly preferred.

As the multifunctional carbodiimides, carbodiimides having a degree of polymerization of 3 to 15 are preferably used. Specific examples thereof include 1,5-naphthalene carbodiimide, 4,4′-diphenylmethane carbodiimide, 4,4′-diphenyl dimethyl methane carbodiimide, 1,3-phenylene carbodiimide, 1,4-phenylene diisocyanate, 2,4-tolylene carbodiimide, 2,6-tolylene carbodiimide, mixtures of 2,4-tolylene carbodiimide and 2,6-tolylene carbodiimide, hexamethylene carbodiimide, cyclohexane-1,4-carbodiimide, xylylene carbodiimide, isophorone carbodiimide, dicyclohexylmethane-4,4′-carbodiimide, methylcyclohexane carbodiimide, tetramethylxylylene carbodiimide, 2,6-diisopropylphenyl carbodiimide, 1,3,5-triisopropyl benzene-2,4-carbodiimide, and the like.

Since isocyanate-based gas is generated due to thermal decomposition, the carbodiimide compound is preferably a highly thermally resistant carbodiimide compound. In order to enhance thermal resistance, the molecular weight (the degree of polymerization) is preferably high, and it is more preferable to provide a highly thermally resistant structure to the terminals of the carbodiimide compound. In addition, once thermal decomposition occurs, additional thermal decomposition is more likely to occur, and thus efforts of setting the extrusion temperature of the polyester as low as possible.

The carbodiimide in the terminal sealant is also preferably a carbodiimide having a ring structure (for example, the carbodiimide having a ring structure described in JP2011-153209A). Carbodiimides having a ring structure develop the equivalent effect as the above-described carbodiimide having a high molecular weight even in the case of having a low molecular weight. This is because the terminal carboxyl groups in the polyester and the cyclic carbodiimide cause a ring-opening reaction, some of the cyclic carbodiimide reacts with the polyester, the remaining ring-opened carbodiimide reacts with other polyesters, and thus the molecular weight increases, which suppresses the generation of isocyanate-based gas.

Among the carbodiimides having a ring structure, in the present disclosure, the terminal sealant is preferably a carbodiimide compound having a ring structure which has carbodiimide groups and in which a first nitrogen atom and a second nitrogen atom are bonded together through a bonding group. Furthermore, the terminal sealant is more preferably a carbodiimide having a ring structure which has at least one carbodiimide group adjacent to an aromatic ring and in which the first nitrogen atom and the second nitrogen atom in the carbodiimide group adjacent to the aromatic ring are bonded together through a bonding group (also referred to as the aromatic cyclic carbodiimide).

The aromatic cyclic carbodiimide may have a plurality of cyclic structures.

The aromatic cyclic carbodiimide may be an aromatic carbodiimide not having a ring structure in which the first nitrogen atoms and the second nitrogen atoms in two or more carbodiimide groups are bonded together through linking groups in the molecule. That is, an aromatic carbodiimide which is a monocycle can be preferably used.

The ring structure has one carbodiimide group (—N═C═N—), and the first nitrogen atom and the second nitrogen atom are bonded together through a bonding group. In a single ring structure, there is only one carbodiimide group; however, for example, in the case of a spirocycle or the like having a plurality of ring structures in the molecule, the compound may have a plurality of carbodiimide groups as long as individual ring structures bonded to spiro atoms have one carbodiimide group. The number of atoms in the ring structure is preferably 8 to 50, more preferably 10 to 30, still more preferably 10 to 20, and particularly preferably 10 to 15.

Here, the number of atoms in the ring structure refers to the number of atoms directly constituting the ring structure, and, for example, the number of atoms constituting the ring structure of an 8-membered ring is 8, and the number of atoms of a 50-membered ring is 50. In a case in which the number of atoms in the ring structure is 8 or more, the stability of the cyclic carbodiimide compound enhances, and it becomes easy to store and use the cyclic carbodiimide compound. There is no particular limitation regarding the upper limit value of the number of ring members from the viewpoint of reactivity, but the difficulty of the synthesis of a cyclic carbodiimide compound having 50 or less atoms is small, and the cost is suppressed at a low level. From the above-described viewpoint, the number of atoms in the ring structure is preferably selected from 10 to 30, more preferably selected from 10 to 20, and particularly preferably selected from a range of 10 to 15.

Specific examples of a carbodiimide-based terminal sealant having a ring structure include the following compounds. However, the present invention is not limited by the following specific examples.

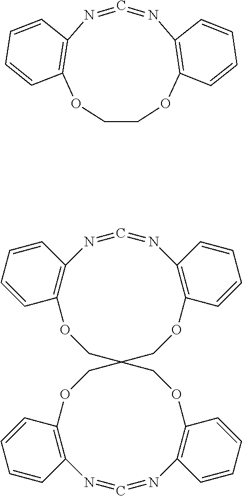 [SMILES: C1=Nc2ccccc2OCCOc2ccccc2N=1 ; C1=Nc2ccccc2OCC2(COc3ccccc3N=1)COc1ccccc1N=C=Nc1ccccc1OC2]

Epoxy-Based Terminal Sealant:

Preferred examples of the epoxy compounds include glycidyl ester compounds, glycidyl ether compounds, and the like.

Specific examples of the glycidyl ester compounds include benzoic acid glycidyl ester, t-Bu-benzoic acid glycidyl ester, p-toluic acid glycidyl ester, cyclohexane carboxylic acid glycidyl ester, pelargonic acid glycidyl ester, stearic acid glycidyl ester, lauric acid glycidyl ester, palmitic acid glycidyl ester, behenic acid glycidyl ester, versatic acid glycidyl ester, oleic acid glycidyl ester, linoleic acid glycidyl ester, behenolic acid glycidyl ester, stearolic acid glycidyl ester, terephthalic acid diglycidyl ester, isophthalic acid diglycidyl ester, phthalic acid diglycidyl ester, naphthalene dicarboxylic acid diglycidyl ester, methyl terephthalate diglycidyl ester, hexahydrophthalic acid diglycidyl ester, tetrahydrophthalic acid diglycidyl ester, cyclohexane dicarboxylic acid diglycidyl ester, adipic acid diglycidyl ester, succinic acid diglycidyl ester, sebacic acid diglycidyl ester, dodecanedioic acid diglycidyl ester, octadecane dicarboxylic acid diglycidyl ester, trimellitic acid triglycidyl ester, pyromellitic acid tetraglycidyl ester, and the like, and one or more glycidyl ester compounds can be used.

Specific examples of the glycidyl ether compounds include phenyl glycidyl ether, o-phenyl glycidyl ether, 1,4-bis(β,γ-epoxypropoxy)butane, 1,6-bis(β,γ-epoxypropoxy)hexane, 1,4-bis(β,γ-epoxypropoxy)benzene, 1-(β,γ-epoxypropoxy)-2-ethoxyethane, 1-(β,γ-epoxypropoxy)-2-benzyloxyethane, bisglycidyl polyethers obtained from a reaction between bisphenol and epichlorohydrin such as 2,2-bis-[p-(β,γ-epoxyphenyl)phenyl]propane, 2,2-bis-(4-hydroxyphenyl)propane, and 2,2-bis-(4-hydroxyphenyl)methane, and the like, and one or more glycidyl ether compounds can be used.

Oxazoline-Based Terminal Sealant:

The oxazoline compound is preferably a bisoxazoline compound, and specific examples thereof include 2,2′-bis(2-oxazoline), 2,2′-bis(4-methyl-2-oxazoline), 2,2′-bis(4,4-dimethyl-2-oxazoline), 2,2′-bis(4-ethyl-2-oxazoline), 2,2′-bis(4,4′-diethyl-2-oxazoline), 2,2′-bis(4-propyl-2-oxazoline), 2,2′-bis(4-butyl-2-oxazoline), 2,2′-bis(4-hexyl-2-oxazoline), 2,2′-bis(4-phenyl-2-oxazoline), 2,2′-bis(4-cyclohexyl-2-oxazoline), 2,2′-bis(4-benzyl-2-oxazoline), 2,2′-p-phenylene bis(2-oxazoline), 2,2′-m-phenylene bis(2-oxazoline), 2,2′-o-phenylene bis(2-oxazoline), 2,2′-p-phenylene bis(4-methyl-2-oxazoline), 2,2′-p-phenylene bis(4,4-dimethyl-2-oxazoline), 2,2′-m-phenylene bis(4-methyl-2-oxazoline), 2,2′-m-phenylene bis(4,4-dimethyl-2-oxazoline), 2,2′-ethylene bis(2-oxazoline), 2,2′-tetramethylene bis(2-oxazoline), 2,2′-hexamethylene bis(2-oxazoline), 2,2′-octamethylene bis(2-oxazoline), 2,2′-decamethylene bis(2-oxazoline), 2,2′-ethylene bis(4-methyl-2-oxazoline), 2,2′-tetramethylene bis(4,4-dimethyl-2-oxazoline), 2,2′-9,9′-diphenoxyethane bis(2-oxazoline), 2,2′-cyclohexylene bis(2-oxazoline), 2,2′-diphenylene bis(2-oxazoline), and the like. Among these, 2,2′-bis(2-oxazoline) is most preferably used from the viewpoint of the reactivity with the polyester. Furthermore, the bisoxazoline compounds described above may be used singly or two or more bisoxazoline compounds may be jointly used as long as the object of the present invention is achieved.

Even in a case in which the terminal sealant is added to, for example, a resin layer on the polyester film, the terminal sealant does not react with the polyester, and thus it is necessary to knead the terminal sealant and cause the terminal sealant to directly react with polyester molecules in the case of manufacturing the polyester film.

(Surface Treatment)

In order to improve the adhesiveness to different kinds of materials, surface treatments such as a corona treatment, a flame treatment, and a glow discharge treatment may be carried out on the white polyester film of the present disclosure.

In the corona discharge treatment, a high frequency and a high voltage are applied between a metallic roll which is generally coated with a dielectric body (dielectric roll) and an insulated electrode so as to cause the insulation breakdown of air between electrodes, whereby the air between the electrodes is ionized and corona discharge is generated between the electrodes. In addition, the surface treatment is carried out by passing the polyester film through between the corona discharges.

Regarding treatment conditions used in the present disclosure, it is preferable that the gap clearance between the electrode and the dielectric roll is 1 mm to 3 mm, the frequency is 1 kHz to 100 kHz, and the applied energy is approximately 0.2 kV·A·minutes/m² to 5 kV·A·minutes/m².

The glow discharge treatment is a method which is also called a vacuum plasma treatment or a low-pressure plasma treatment and in which plasma is generated through discharging in a gas in a low-pressure atmosphere (plasma gas), thereby treating the surface of a film. Low-pressure plasma used in the glow discharge treatment of the present disclosure is non-equilibrium plasma generated under conditions in which the pressure of the plasma gas is low. The glow discharge treatment of the polyester film is carried out by placing a film to be treated (polyester film) in this low-pressure plasma atmosphere.

As the method for generating plasma in the glow discharge treatment, it is possible to use a method of direct-current glow discharge, high-frequency discharge, microwave discharge, or the like. The power supply used for the discharge may be a direct current or an alternating current. In a case in which an alternating current is used, the frequency is preferably in a range of approximately 30 Hz to 20 MHz.

In a case in which an alternating current is used, a commercial frequency of 50 Hz or 60 Hz may be used or a high frequency of approximately 10 kHz to 50 kHz may be used. In addition, a method of using a high frequency of 13.56 MHz is also preferred.

As the plasma gas used in the glow discharge treatment, it is possible to use an inorganic gas such as oxygen gas, nitrogen gas, water vapor gas, argon gas, or helium gas, and oxygen gas or a gas mixture of oxygen gas and argon gas is particularly preferred. Specifically, the gas mixture of oxygen gas and argon gas is more desirably used. In a case in which a gas mixture of oxygen gas and argon gas is used, the partial pressure ratio between both gases (oxygen gas and argon gas) is preferably 100:0 to 30:70 and more preferably approximately 90:10 to 70:30. In addition, particularly, a method in which gas is not introduced into a treatment container, and gases such as air entering the treatment container through leaking and water vapor emitted from a substance to be treated are used as the plasma gas is also preferred.

Here, as the pressure of the plasma gas, a low pressure capable of achieving non-equilibrium plasma conditions is required. A specific pressure of the plasma gas is preferably approximately 0.005 Torr to 10 Torr (0.666 to 1,333 Pa) and more preferably in a range of approximately 0.008 Torr to 3 Torr (1.067 to 400 Pa). In a case in which the pressure of the plasma gas is 0.666 Pa or higher, the adhesiveness-improving effect becomes sufficient, and, in a case in which the pressure of the plasma gas is 1,333 Torr or less, discharging becoming unstable due to an increase in an electric current is suppressed.

While it is not possible to determine the specific value of the plasma output since the plasma output varies depending on the shape and size of the treatment container, the shape of the electrode, and the like, the plasma output is preferably approximately 100 W to 2,500 W and more preferably approximately 500 W to 1,500 W.

The treatment time of the glow discharge treatment is preferably 0.05 seconds to 100 seconds and more preferably approximately 0.5 seconds to 30 seconds. In a case in which the treatment time is 0.05 seconds or longer, the adhesiveness-improving effect can be sufficiently obtained, and, in a case in which the treatment time is 100 seconds or shorter, it is possible to prevent the deformation, coloration, and the like of a film to be treated.

The discharge treatment intensity of the glow discharge treatment varies depending on the plasma output and the treatment time, but is preferably in a range of 0.01 kV·A·minutes/m² to 10 kV·A·minutes/m² and more preferably 0.1 kV·A·minutes/m² to 7 kV·A·minutes/m².

In a case in which the discharge treatment intensity is set to 0.01 kV·A·minutes/m² or higher, a sufficient adhesiveness-improving effect can be obtained, and, in a case in which the discharge treatment intensity is set to 10 kV·A·minutes/m² or lower, it is possible to avoid the deformation, discoloration, and the like of the film to be treated.

In the glow discharge treatment, it is also preferable to heat the film to be treated in advance. In such a case, compared with a case in which the film is not heated, favorable adhesiveness can be obtained within a short period of time. The temperature of the heating is preferably in a range of 40° C. to the softening temperature of the film to be treated +20° C. and more preferably in a range of 70° C. to the softening temperature of the film to be treated. In a case in which the temperature of the heating is set to 40° C. or higher, a sufficient adhesiveness-improving effect can be obtained. In addition, in a case in which the temperature of the heating is set to the softening temperature or lower of the film to be treated, it is possible to ensure favorable handling properties of the film during the treatment.

Specific examples of a method for increasing the temperature of the film to be treated in a vacuum include heating using an infrared heater and heating by bringing the film into contact with a hot roll.

Examples of the flame treatment include flame treatments in which flame into which silane compounds are introduced is used.

<Method for Manufacturing White Polyester Film>

The method for manufacturing the white polyester film of the present disclosure is not particularly limited, and the white particles can be blended into the polyester film using a variety of well-known methods. Typical examples of the method include the following method.
(A) A method in which the white particles are added before the end of an ester exchange reaction or an esterification reaction in the synthesis of the polyester or the white particles are added before the initiation of a polycondensation reaction
(B) A method in which the white particles are added to the polyester and are melted and kneaded
(C) A method in which a master batch (also referred to as a master pellet) to which a large amount of the white particles are added using the method (A) or (B) is manufactured, the master batch and a polyester containing no white particles or a small amount of a white pigment are kneaded together, thereby adding a predetermined amount of the white particles
(D) A method in which the white particles are melted and kneaded using the master pellet in (C)

Among these, the method (C), that is, the method in which a master batch to which a large amount of the white particles are added is manufactured, the master batch and a polyethylene terephthalate containing no white particles or a small amount of a white pigment are kneaded together, thereby adding a predetermined amount of the white particles (hereinafter, in some cases, referred to as “master batch method”) is preferred. In addition, it is also possible to employ a method in which a polyester that has not been dried in advance and white particles are injected into an extruder, and a master batch is produced while degassing moisture, the air, and the like. Furthermore, it is preferable to produce a master batch using a polyester that has been dried in advance even to a small extent since an increase in the acid value of the polyester is suppressed. In this case, examples of the method include a method of carrying out extrusion while degassing, a method of carrying out extrusion without degassing using a polyester that has been sufficiently dried, and the like.

The white polyester film of the present disclosure can be preferably manufactured using the following method.

That is, a method for manufacturing a white polyester film in which a polyester A and a polyester B in which the intrinsic viscosity IV_{A} of the polyester A and the intrinsic viscosity IV_{B} of the polyester B satisfy Expressions (I) and (II) are used, the method including a master batch preparation step of preparing a master batch including the polyester A and 40% to 60% by mass of white particles having an average primary particle diameter of 0.20 to 0.40 μm, an extrusion step of forming a non-stretched film by supplying the master batch and the polyester B to an extruder and melting and extruding a molten resin on a cooling roll while controlling the number of rotations N per minute of a screw in the extruder, an extrusion amount Q of the molten resin from an outlet of the extruder per hour, and an inner diameter D of a cylinder in the extruder to satisfy Expression (III), and a stretching step of stretching the non-stretched film in at least one direction,

IV_{A}+0.12<IV_{B} (I)

IV_{B}>0.74 (II)

3.0×10⁻⁶×D^{2.8}<Q/N<9.0×10⁻⁶×D^{2.8} (III)
a unit of N is min⁻¹, a unit of Q is kg/h, a unit of D is mm, and units of IV_{A} and IV_{B} are all dL/g.

(Polyester A and Polyester B)

First, the polyesters that are used in the method for manufacturing the white polyester film of the present disclosure will be described. In the present disclosure, two kinds of polyesters having different intrinsic viscosities (IV), that is, the polyester A and the polyester B in which the intrinsic viscosity IV_{A} (dL/g) of the polyester A and the intrinsic viscosity IV_{B} (dL/g) of the polyester B satisfy Expressions (I) and (II) are used. Specifically, as the polyester that is used as a raw material for manufacturing a master batch, the polyester A is used. In addition, as raw materials for forming the white polyester film, the master batch and the polyester B are used.

In a case in which the intrinsic viscosity IV_{B} of the polyester B that is used in the case of forming the polyester film is more than 0.74, an increase in the concentration of the terminal carboxyl groups in the polyester film is suppressed, and the degradation of the hydrolysis resistance is suppressed.

Meanwhile, in a case in which 0.12+the intrinsic viscosity IV_{A} of the polyester A that is used in the case of manufacturing the mater batch including the white particles is smaller than the intrinsic viscosity IV_{B} of the polyester B, the melt viscosity of the master batch to be obtained becomes relatively small compared with the melt viscosity of the polyester B that is used as a raw material for the film, and it becomes easy to control the particle diameters of the agglomerated particles in a preferred range in the extrusion step, and consequently, polyester films capable of obtaining a sufficient reflectivity in the near-infrared range can be manufactured.

A mechanism by which the particle diameters of the agglomerated particles can be controlled to a preferred range in an extrusion step by setting the intrinsic viscosity IV_{A} of the polyester A and the intrinsic viscosity IV_{B} of the polyester B in the above-described range will be described below. In the case of manufacturing the polyester film, in the extrusion step, the white particles included in the master batch also gradually disperse in the polyester that is supplied together with the master batch. At this time, in a case in which the master batch produced using the polyester A having a low intrinsic viscosity IV_{A} is mixed with the polyester B having an intrinsic viscosity IV_{B} which is greater than 0.74 dL/g and 0.12 dL/g or more higher than the IV_{A} of the polyester A, and the mixture is melted and kneaded together, the time necessary for the polyester B and the master batch to be uniformly mixed becomes longer compared with a case in which the IV_{B} of the polyester B is not 0.12 dL/g or more higher than the IV_{A} of the polyester A. As a result, it is considered that the dispersion of the white particles included in the master batch in a high concentration in the polyester B is delayed, and thus the agglomeration of the white particles is induced, and some of the white particles are present in an agglomerated particle form having particle diameters in the film surface direction of 0.40 to 0.80 μm.

From such a viewpoint, it is preferred that IV_{A}+0.17<IV_{B} and IV_{B}>0.76.

In a case in which the intrinsic viscosity IV_{B} of the polyester B is too high, there is a tendency that kneading and extrusion in extruders are hindered, and thus the intrinsic viscosity IV_{B} of the polyester B is preferably 0.88 dL/g or less and more preferably 0.84 dL/g or less.

The intrinsic viscosities of the polyester A and the polyester B are obtained from the solution viscosity of the polyester at 25° C. in a 1,1,2,2-tetrachloroethane/phenol (=2/3 [mass ratio]) solvent mixture in which the polyester has been dissolved.

ηsp/C=[η]+K[η]2·C

Here, ηsp=(solution viscosity/solvent viscosity)−1, C represents the mass of the polymer dissolved in 100 ml of the solvent (set to 1 g/100 ml in the present measurement), and K represents the Huggis constant (set to 0.343). The solution viscosity and the solvent viscosity were respectively measured using an Ostwald viscometer.

In addition, in a case in which the white polyester film of the present disclosure is manufactured using the master batch method, the supply amount of the polyester B is greater than the supply amount of the master batch, and thus the concentration of terminal carboxyl groups in the polyester film to be manufactured is more significantly affected by terminal carboxyl groups in the polyester B than in the polyester A. From the viewpoint of the adhesiveness and hydrolysis resistance of the white polyester film, the concentration of the terminal carboxyl groups in the polyester B is preferably 6 to 24 equivalents/ton and more preferably 6 to 18 equivalents/ton.

In the case of polymerizing the polyesters (the polyester A and the polyester B) that are used in the method for manufacturing the white polyester film of the present disclosure, from the viewpoint of suppressing the concentration of the terminal carboxyl groups at a low level, a Sb-based, Ge-based, or Ti-based compound is preferably used as a catalyst, and, among these, a Ti-based compound is particularly preferred. In a case in which a Ti-based compound is used, an aspect in which the polyesters are polymerized using the Ti-based compound in a range of 1 ppm or more and 30 ppm or less and more preferably 3 ppm or more and 15 ppm or less as a catalyst is preferred. In a case in which the ratio of the Ti-based compound is in the above-described range, it is possible to adjust the concentration of the terminal carboxyl groups to a range described below and maintain the hydrolysis resistance of the polymer at a high level.

To the synthesis of the polyesters in which the Ti-based compound is used, the methods described in, for example, JP1996-301198B (JP-H08-301198B), JP2543624B, JP3335683B, JP3717380B, JP3897756B, JP3962226B, JP3979866B, JP3996871B, JP4000867B, JP4053837B, JP4127119B, JP4134710B, JP4159154B, JP4269704B, JP4313538B, and the like can be applied.

The concentrations of the terminal carboxyl groups in the respective polyesters can be obtained using the above-described method.

The concentrations of the carboxyl groups in the polyester can be adjusted using the kind of polymerization catalyst, manufacturing conditions (temperature and time), and the like.

In addition, the polyesters that are used in the method for manufacturing the white polyester film of the present disclosure, particularly, the polyester B has a significant influence on the concentration of the terminal carboxyl groups in the polyester film and is thus preferably solid-phase-polymerized after polymerization. A preferred concentration of the terminal carboxyl groups can be achieved by solid-phase polymerization. The solid-phase polymerization may be a continuous method (a tower is filled with a resin, the resin is slowly retained for a predetermined time while being heated and is sent out) or a batch method (a method in which a resin is injected into a container and is heated for a predetermined time). Specifically, to the solid-phase polymerization, the method described in JP2621563B, JP3121876B, JP3136774B, JP3603585B, JP3616522B, JP3617340B, JP3680523B, JP3717392B, JP4167159B, and the like can be applied.

The temperature during the solid-phase polymerization is preferably 150° C. to 250° C., more preferably 170° C. to 240° C., and still more preferably 180° C. to 230° C. In addition, the solid-phase polymerization time is preferably 1 to 50 hours, more preferably 5 to 40 hours, and still more preferably 10 to 30 hours. The solid-phase polymerization is preferably carried out in a vacuum or a nitrogen atmosphere.

[Master Batch Preparation Step]

In the master batch preparation step, a master batch including the polyester A and 40% to 60% by mass of white particles having an average primary particle diameter of 0.20 to 0.40 μm (hereinafter, in some cases, abbreviated as “MB”) is prepared.

(Mater Batch)

As described above, the method for adding the white particles in the method for manufacturing the white polyester film of the present disclosure is preferably the use of the master batch method. The master batch method is a method in which a master batch (in some cases, also referred to as the master pellet) is manufactured by kneading the polyester A and a large amount of the white particles in an extruder in advance, and subsequently, the master batch and a polyester containing no white particles or a small amount of white particles are kneaded together at an arbitrary ratio in the extruder, thereby adding a predetermined amount of the white particles.

The polyester A which serves as a raw material of the master batch controls the particle diameters of agglomerated particles formed due to the agglomeration of the white particles that are dispersed in the film and thus preferably has a relatively low melt viscosity and a high concentration of the terminal carboxyl groups.

In a step of manufacturing the master batch, the thermal decomposition and hydrolysis of the polyester film occur, and the concentration of the terminal carboxyl groups increases. Therefore, the concentration of the terminal carboxyl groups in the master batch to be manufactured generally tends to increase.

The intrinsic viscosity IV_{A} of the polyester A that is used for the manufacturing of the master batch is preferably 0.50 to 0.80 dL/g and more preferably 0.55 to 0.70 dL/g.

In addition, the concentration of the terminal carboxyl groups in the polyester A is preferably 10 to 30 equivalents/ton and more preferably 10 to 25 equivalents/ton.

In addition, in the case of producing the master batch (MB), it is preferable to reduce the moisture ratio by drying a polyester A in advance. Regarding the drying conditions, the drying temperature is preferably 100° C. to 200° C. and more preferably 120° C. to 180° C., and the drying time is one hour or longer, more preferably three hours or longer, and still more preferably six hours or longer. In this case, the polyester is sufficiently dried so that the amount of moisture in the polyester resin preferably reaches 100 ppm or less, more preferably reaches 50 ppm or less, and particularly preferably reaches 30 ppm or less.

The method for carrying out preliminary mixing is not particularly limited, and preliminary mixing may be carried out using a method by batch or a monoaxial or multiaxial kneading and extrusion device. In the case of producing the master batch while degassing, it is preferable to employ a method in which a polyester is melted at a temperature of 250° C. to 300° C. and preferably 270° C. to 280° C., provide one degassing opening, preferably, two or more degassing openings to a preliminary mixer, carry out continuous suction and degassing at 0.05 MPa or higher and more preferably 0.1 MPa or higher, and maintain the reduced pressure in the mixer.

The average primary particle diameter of the white particles in the master batch is 0.20 to 0.40 μm, and the content of the white particles is set to 40% to 60% by mass.

In a case in which the content of the white particles in the master batch is set to 40% by mass or more, at the time of manufacturing the polyester film, it is possible to control the particle diameters of the agglomerated particles to a preferred range in the extrusion step. On the other hand, in a case in which the content of the white particles in the master batch is set to 60% by mass or less, an increase in the concentration of the terminal carboxyl groups in the step of manufacturing the master batch is suppressed to a small extent, and consequently, it is possible to suppress an increase in the concentration of the terminal carboxyl groups in the polyester film and suppress the degradation of the hydrolysis resistance.

From such a viewpoint, the content of the white particles in the master batch is preferably 45% to 55% by mass.

[Extrusion Step]

In the extrusion step, the master batch and the polyester B are supplied to one extruder, melted and kneaded together, and the molten resin is melted and extruded onto a cooling roll while controlling the number of rotations N per minute (min⁻¹) of the screw in the extruder, the extrusion amount Q (kg/h) of the molten resin from the outlet of the extruder per hour, and the inner diameter D (mm) of the cylinder in the extruder to satisfy Expression (III), thereby forming a non-stretched film.

3.0×10⁻⁶×D^{2.8}<Q/N<9.0×10⁻⁶λD^{2.8} (III)

For example, the master batch and the polyester B may be supplied to the extruder using mutually different suppliers, and the supply amounts of the master batch and the polyester B are adjusted so that the content of the white particles in the polyester film reaches a predetermined value (1.0% to 5.0% by mass).

(Supply Amount of Polyester B)

The supply amount of the polyester B that is supplied to the extruder using a supplier is preferably set to 500 to 5,000 kg/h. In a case in which the supply amount of the polyester B is 500 kg/h or more, it is possible to use extruders having a relatively large diameter and obtain a sufficient reflectivity in the near-infrared range by controlling the particle diameters of the agglomerated particles of the white particles in the film to a preferred range. On the other hand, in a case in which the supply amount of the polyester B is 5,000 kg/h or less, it is not necessary to use extruders having a relatively large diameter, the retention time inside the extruder does not become too long, and it is possible to suppress the degradation of the hydrolysis resistance caused by the progress of the thermal decomposition of the polyester.

Meanwhile, similar to the polyester A that is used for the master batch, the polyester B is also preferably dried in advance, thereby reducing the moisture ratio.

To the supply amount of the polyester B, it is preferable to impart a fluctuation of ±1.0% to ±5.0% of the average supply amount (average value) per unit time. For example, imparting a fluctuation of ±2.0% of the average value means that, in a case in which the polyester B is continuously supplied to the extruder using a supplier and the average supply amount of the polyester B per unit time is set to 100 parts by mass/h, the supply amount of the polyester B is continuously or intermittently changed in a range of 98 to 102 parts by mass/h. In a case in which the supply amount of the polyester B is fluctuated, the concentration of the white particles to be dispersed in the polyester fluctuates, and it is possible to affect the agglomeration of the particles. In a case in which the fluctuation of the supply amount of the polyester B is ±1.0% or more of the average value, it is possible to obtain a sufficient reflectivity in the near-infrared range by controlling the particle diameters of the agglomerated particles of the white particles in the film in a preferred range. In addition, in a case in which the fluctuation of the supply amount of the polyester B is ±5.0% or less of the average value, the variation of the particle diameters of the white particles is suppressed in a preferred range, and a sufficient reflectivity in the visible light range can be obtained. Additionally, coarse agglomerated particles are not easily formed, fractures initiating from the agglomerated particles are not easily generated, and the degradation of the hydrolysis resistance is suppressed.

Meanwhile, even in a case in which the supply amount of the polyester B that is supplied to the extruder is fluctuated to a certain extent, the fluctuation of the film thickness can be suppressed by stabilizing the flow rate of the molten resin using a gear pump.

Regarding the supply amount of the master batch, the master batch may be supplied so that the content of the white particles in the film reaches 1.0% to 5.0% by mass in consideration of the content of the white particles in the master batch and the supply amount of the polyester B.

Meanwhile, in the extrusion step, the number of rotations N per minute (min⁻¹) of the screw in the extruder, the extrusion amount Q (kg/h) of the molten resin from the outlet of the extruder per hour, and the inner diameter D (mm) of the cylinder in the extruder are controlled so as to satisfy Expression (III).

3.0×10⁻⁶×D^{2.8}<Q/N<9.0×10⁻⁶×D^{2.8} (III)

Here, Q/N represents the amount extruded per rotation of the screw, and the expression indicates that it is preferable to increase this value in proportion to the 2.8^{th} power of the inner diameter D (mm) of the cylinder in the extruder. In a case in which the coefficient of D^{2.8} shown in Expression (III) is controlled to 3.0×10⁻⁶ or more, it is possible to suppress an increase in the concentration of the terminal carboxyl groups. In a case in which the coefficient of D^{2.8} shown in Expression (III) is controlled to 9.0×10⁻⁶ or less, it is possible to control the particle diameters of the agglomerated particles to a preferred range. From such a viewpoint, the coefficient of D^{2.8} shown in Expression (III) is more preferably controlled to 6.5×10⁻⁶ to 8.5×10⁻⁶.

Meanwhile, the supply amount of the raw materials to the extruder and the extrusion amount of the molten resin from the extruder can be handled in the same manner, and, when the supply amount of the raw material resin to the extruder is represented by Q (kg/h), the extrusion amount of the molten resin from the extruder may be considered to be Q (kg/h).

[ Stretching Step]

In the stretching step, the non-stretched film is stretched in at least one direction.

Biaxial stretching in which, with respect to the glass transition temperature Tg of the polyester in the non-stretched film, the non-stretched film is stretched once or more in the longitudinal direction (also referred to as the transportation direction or machine direction (MD) of the film) at Tg to (Tg+60° C.) so that the total stretch ratio reaches three to six times, and then is stretched in the width direction (also referred to as the direction orthogonal to MD (transverse direction (TD)) at Tg to (Tg+60° C.) so that the stretch ratio reaches three to five times is preferably carried out.

Meanwhile, the agglomerated particles in the non-stretched film can be oriented in the stretching directions by means of stretching, and it is possible to manufacture polyester films including 10% to 20% by number of 0.40 to 0.80 μm agglomerated particles using a small amount of the white particles.

Furthermore, a thermal treatment may be carried out as necessary at 180° C. to 230° C. for 1 second to 60 seconds.

<Solar Cell Back Sheet>

The white polyester film of the present disclosure is excellent in terms of the hydrolysis resistance, the reflectivity in the visible light range, and the reflectivity in the near-infrared range and is thus preferable as a base material film of solar cell back sheets. That is, the solar cell back sheet of the present disclosure includes the above-described white polyester film of the present disclosure.

Meanwhile, the solar cell back sheet of the present disclosure may have a layer constitution in which one or more functional layers are laminated on the above-described white polyester film of the present embodiment as necessary. As the functional layers that are laminated on the white polyester film of the present embodiment, for example, an easy-adhesion layer for enhancing the adhesiveness to sealing materials may be provided on one surface of the white polyester film of the present embodiment, or a weather-resistant layer for improving the weather resistance may be provided on a surface on the opposite side.

The materials and thicknesses of the functional layers may be appropriately selected depending on required functions.

<Solar Cell Module>

A solar cell module of the present disclosure includes a solar cell element, a sealing material that seals the solar cell element, a front substrate disposed on the outside of the sealing material on a light-receiving surface side of the solar cell element, and the solar cell back sheet according to the above-described embodiment disposed on the outside of the sealing material on a side opposite to the light-receiving surface side of the solar cell element.

That is, the solar cell module of the present disclosure is constituted by disposing a solar cell element that converts the light energy of sunlight to an electric energy between a transparent front substrate (front surface protection member) on which the sunlight is incident and the solar cell back sheet of the present disclosure described above (rear surface protection member) and sealing the solar cell element disposed between the front substrate and the back sheet with a sealing material such as ethylene vinyl acetate (EVA). The solar cell module includes the solar cell back sheet including the white polyester film of the present disclosure, whereby the occurrence of peeling and cracking caused by the hydrolysis of the solar cell back sheet is suppressed, and the power generation efficiency can be enhanced by reflecting light rays in the visible light range and the near-infrared range toward the solar cell element at a high reflectivity. Therefore, the solar cell module of the present disclosure is capable of maintaining a high power generation efficiency outdoors for a long period of time.

Regarding members other than the solar cell module, the solar cell, and the back sheet, for example, “The Constituent Materials of Photovoltaic Power Generation Systems” (edited by Eiichi Sugimoto and published by Kogyo Chosakai Publishing Co., Ltd. in 2008) describes the members in detail.

The transparent front substrate needs to have a light-transmitting property so as to be capable of transmitting sunlight and can be appropriately selected from base materials transmitting light. From the viewpoint of power generation efficiency, the light transmittance of the substrate is preferably higher, and, as the above-described substrate, for example, a glass substrate, a transparent resin substrate such as an acrylic resin, or the like can be preferably used.

As the solar cell element, it is possible to apply a variety of well-known solar cell elements such as a solar cell element based on silicon such as monocrystalline silicon, polycrystalline silicon, or amorphous silicon or a solar cell element based on a III-V group or II-VI group compound semiconductor such as copper-indium-gallium-selenium, copper-indium-selenium, cadmium-tellurium, or gallium-arsenic.

The white polyester film of the present disclosure is preferable as a base material film of the solar cell back sheet, but the applications of the white polyester film of the present disclosure is not limited to solar cell back sheets, and can be used as films which are used outdoors for a long period of time and reflect or shield visible light and near-infrared rays. Specific examples thereof include construction films, outdoor advertisement films, heat barrier films, and the like as well as solar cell protective films.

### EXAMPLES

Hereinafter, the present invention will be more specifically described using examples, but the present invention is not limited to the following examples within the scope of the gist of the present invention. Meanwhile, unless particularly otherwise described, “parts” is on the basis of mass.

### Example 1

<Synthesis of Polyester A>

In a first esterification reaction tank, highly pure terephthalic acid (4.7 ton) and ethylene glycol (1.8 ton) were mixed together for 90 minutes so as to form a slurry, and the slurry was continuously supplied to the first esterification reaction tank at a flow rate of 3,800 kg/h. Furthermore, an ethylene glycol solution of a citric acid chelate titanium complex (VERTEC AC-420, manufactured by Johnson Matthey) in which citric acid coordinated Ti metal was continuously supplied, and a reaction was caused under stirring at an inner temperature of the reaction tank of 250° C. for an average residence time of approximately 4.3 hours. At this time, the citric acid chelate titanium complex was continuously added so that the amount of Ti added reached 9 ppm in terms of the Ti element. At this time, the acid value of the obtained oligomer was 600 equivalents/ton.

This reaction product was transferred to a second esterification reaction tank and was reacted under stirring at an inner temperature of the reaction tank of 250° C. for an average residence time of 1.2 hours, thereby obtaining an oligomer having an acid value of 200 equivalents/ton. The inside of the second esterification reaction tank was divided into three zones, an ethylene glycol solution of magnesium acetate was continuously supplied from a second zone so that the amount of Mg added reached 67 ppm in terms of the element equivalent value, and subsequently, an ethylene glycol solution of trimethyl phosphate was continuously supplied from a third zone so that the amount of P added reached 65 ppm in terms of the element equivalent value.

—Polycondensation Reaction—

The esterification reaction product obtained above was continuously supplied to a first polycondensation reaction tank and was polycondensed under stirring at a reaction temperature of 270° C. and an inner pressure of the reaction tank of 2.67×10⁻³ MPa (20 torr) for an average residence time of approximately 1.8 hours.

The reaction product that had passed through the first polycondensation reaction tank was further transferred to a second polycondensation reaction tank and was reacted (polycondensed) in this reaction tank under stirring at an inner temperature of the reaction tank of 276° C. and an inner pressure of the reaction tank of 6.67×10⁻⁴ MPa (5 torr) for an average residence time of approximately 1.2 hours.

Next, the reaction product that had passed through the second polycondensation reaction tank was further transferred to a third polycondensation reaction tank and was reacted (polycondensed) in this reaction tank under conditions of an inner temperature of the reaction tank of 278° C., an inner pressure of the reaction tank of 2.0×10⁻⁴ MPa (1.5 torr), and an average residence time of 1.5 hours, thereby obtaining a reaction product (hereinafter abbreviated as PET).

On the obtained PET (reaction product), the contents of the elements were measured using a high resolution inductively coupled plasma mass spectrometry (H-ICP-MS; AttoM manufactured by Seiko Instruments Inc.). As a result, Ti=9 ppm, Mg=67 ppm, and P=58 ppm. P was slightly reduced with respect to the original amount added and was assumed to have been volatilized in the polymerization process.

A pellet (diameter: 3 mm, length: 7 mm) was produced from PET polymerized above. The obtained resin had an IV of 0.60 dL/g and a concentration of the terminal carboxyl groups of 25 equivalents/ton.

<Synthesis of Polyester B>

—Esterification—

In a first esterification reaction tank, highly pure terephthalic acid (4.7 ton) and ethylene glycol (1.8 ton) were mixed together for 90 minutes so as to form a slurry, and the slurry was continuously supplied to the first esterification reaction tank at a flow rate of 3,800 kg/h. Furthermore, an ethylene glycol solution of a citric acid chelate titanium complex (VERTEC AC-420, manufactured by Johnson Matthey) in which citric acid coordinated Ti metal was continuously supplied, and a reaction was caused under stirring at an inner temperature of the reaction tank of 250° C. for an average residence time of approximately 4.3 hours. At this time, the citric acid chelate titanium complex was continuously added so that the amount of Ti added reached 9 ppm in terms of the element equivalent value. The acid value of the obtained oligomer was 600 equivalents/ton.

The obtained reaction product (oligomer) was transferred to a second esterification reaction tank and was reacted under stirring at an inner temperature of the reaction tank of 250° C. for an average residence time of 1.2 hours, thereby obtaining an oligomer having an acid value of 200 equivalents/ton. The inside of the second esterification reaction tank was divided into three zones, an ethylene glycol solution of magnesium acetate was continuously supplied from a second zone so that the amount of Mg added reached 67 ppm in terms of the element equivalent value, and subsequently, an ethylene glycol solution of trimethyl phosphate was continuously supplied from a third zone so that the amount of P added reached 65 ppm in terms of the element equivalent value.

—Polycondensation Reaction—

The esterification reaction product obtained above was continuously supplied to a first polycondensation reaction tank and was polycondensed under stirring at a reaction temperature of 270° C. and an inner pressure of the reaction tank of 20 torr (2.67×10⁻³ MPa) for an average residence time of approximately 1.8 hours.

The reaction product that had passed through the first polycondensation reaction tank was further transferred to a second polycondensation reaction tank and was reacted (polycondensed) in this reaction tank under stirring at an inner temperature of the reaction tank of 276° C. and an inner pressure of the reaction tank of 5 torr (6.67×10⁻⁴ MPa) for an average residence time of approximately 1.2 hours.

Next, the reaction product that had passed through the second polycondensation reaction tank was further transferred to a third polycondensation reaction tank and was reacted (polycondensed) in this reaction tank under conditions of an inner temperature of the reaction tank of 278° C., an inner pressure of the reaction tank of 1.5 torr (2.0×10⁻⁴ MPa), and an average residence time of 1.5 hours, thereby obtaining polyethylene terephthalate (PET).

On the obtained PET (reaction product), measurement was carried out using a high resolution inductively coupled plasma mass spectrometry (HR-ICP-MS; AttoM manufactured by Seiko Instruments Inc.). As a result, Ti=9 ppm, Mg=67 ppm, and P=58 ppm. P was slightly reduced with respect to the original amount added and was assumed to have been volatilized in the polymerization process.

—Solid Phase Polymerization—

A pellet (diameter: 3 mm, length: 7 mm) was produced from PET polymerized above, and solid phase polymerization was carried out on the obtained resin pellet (IV=0.60 dL/g, concentration of terminal carboxyl groups=25 equivalents/ton) as described below.

In the solid phase polymerization, the polyester polymerized by the above-described esterification reaction was heated using nitrogen (the dew-point temperature−30° C.) at 140° C. for seven minutes, and preliminary crystallization was carried out for the purpose of preventing fixation during the solid phase polymerization.

Next, the polyester was dried at 165° C. for four hours using heated nitrogen (the dew-point temperature−30° C.), and the moisture ratio in the resin was set to 50 ppm or less.

Next, the dried polyester resin was preliminarily heated at 205° C., and then nitrogen was circulated at 207° C. for 25 hours, thereby causing the solid phase polymerization to proceed. As the nitrogen circulation conditions, the gas ratio (the amount of nitrogen gas being circulated to the amount of the resin being discharged) was set to 1.5 m³/kg, the superficial velocity was set to 0.08 m/second, the concentration of ethylene glycol was set to 240 ppm, the concentration of water was set to 12 ppm, and nitrogen gas having a molar partial pressure ratio of ethylene glycol to water (the molar partial pressure of ethylene glycol/the molar partial pressure of water) of 20 was used, thereby causing the solid phase polymerization to proceed. In order to obtain the above-described gas mixture composition, highly pure ethylene glycol having a water content ratio of 100 ppm was used as the ethylene glycol scrubber, and the temperature of the scrubber was set to 35° C. The pressure in the scrubber was set in a range of 0.1 MPa to 0.11 MPa.

Next, the resin (500 kg/h) discharged from the reaction step was cooled to 60° C. The obtained resin had an IV of 0.78 dL/g and a concentration of the terminal carboxyl groups of 9 equivalents/ton.

<Production of Master Batch>

The polyester A and titanium oxide particles (manufactured by Ishihara Sangyo Kaisha, Ltd., trade name: PF-739, average primary particle diameter: 0.25 μm) were kneaded together in an extruder so that the content of the titanium oxide particles reached 40% to 60% by mass, thereby producing a master batch (master pellet).

<Formation of Film by Extrusion>

The polyester B and the master pellet were respectively dried so that the water contents reached 100 ppm or less, respectively supplied to the extruder using separate suppliers at a ratio in which the concentration of the titanium oxide in the film reached 3.0% by mass, and melted and extruded at 285° C. (the temperature at the outlet of the extruder). As the extruder, a double vent-type identical direction rotary engagement-type biaxial extruder including vents at two places was used.

Meanwhile, the average supply amount of the polyester B per unit time was set to 2,350 kg/h, and the supply rate was fluctuated in a range of ±1.2%.

In addition, the number of rotations N per minute of the screw in the extruder was set to 150 min⁻¹, and the extrusion amount Q of the molten resin from the outlet of the extruder per hour was set to 2,500 kg/h respectively, thereby controlling Q/N to 16.7 kg·min/h.

The molten body (melt) extruded from the outlet of the extruder was passed through a gear pump and a metal fiber filter (pore diameter: 20 μm) and then extruded from a die to a cooling roll. The extruded melt was adhered to the cooling roll using an electrostatic application method. As the cooling roll, a hollow cast roll was used, and the cooling roll was constituted so that the temperature could be adjusted by passing water as a heat medium through the cooling roll.

<Stretching and Winding>

On the non-stretched film that had been extruded and solidified on the cooling roll using the above-described method, subsequently, biaxial stretching was carried out using the following method, thereby obtaining a 305 μm-thick film. Meanwhile, regarding the stretching, machine stretching was carried out at 95° C., and then transverse stretching was carried out at 120° C. After that, the film was heat-fixed at 210° C. for 12 seconds and then relaxed 3% at 205° C. in the transverse direction.

After the stretching, both ends were respectively trimmed 10 cm, both ends were embossed, and then 3,000 m of the film was wound around a resin winding core having a diameter of 30 cm. Meanwhile, the film width was 1.5 m.

—Machine Stretching—

The non-stretched film was passed through between two pairs of nip rolls having different circumferential velocities and stretched in the machine direction (transportation direction) under the following conditions.
Preheating temperature: 95° C.
Stretching temperature: 95° C.
Stretch ratio: 3.5 times
Stretching rate: 300%/second

—Transverse Stretching—

The machine-stretched film was stretched in the transverse direction (the direction perpendicular to the transportation direction) under the following conditions using a tenter.
Preheating temperature: 110° C.
Stretching temperature: 120° C.
Stretch ratio: 3.9 times
Stretching rate: 15%/second

[Evaluations of Films]

On the obtained white polyester films, the following measurement and evaluations were carried out.

—Content of White Particles—

The content of the white particles in the film was a parameter expressed by a percentage of the ratio of the mass of the white particles to the mass of the entire film and, specifically, was measured using the following method.

3 g of the film was placed in a crucible as a measurement specimen and was heated at 900° C. for 120 minutes in an electric oven. After that, the crucible was removed while cooling the measurement specimen in the electric oven, and the mass of ash remaining in the crucible was measured. This ash was the component of the white particles, and a value obtained by dividing the mass of the ash by the mass of the measurement specimen and multiplying the result by 100 was used as the content (% by mass) of the white particles.

—Concentration of Terminal Carboxyl Groups—

0.1 g of a specimen obtained by cutting the film was dissolved in 10 ml of benzyl alcohol, then, a phenol red indicator was added dropwise to a solution mixture to which chloroform was added, and this solution was titrated with a reference liquid (0.01 mol/L KOH-benzyl alcohol solution mixture). The concentration of the terminal carboxyl groups [equivalents/ton] was computed from the titration amount.

—Hydrolysis Resistance—

On the obtained films, a treatment was carried out for a predetermined time under heat and humidity conditions of 120° C. and 100%, and then, the fracture elongations were measured using JIS-K7127 method and evaluated according to the following evaluation standards.
A: The time taken for the fracture elongation to decrease to 50% of the non-stretched film is longer than 105 hours
B: The time taken for the fracture elongation to decrease to 50% of the non-stretched film is longer than 95 hours and 105 hours or shorter
C: The time taken for the fracture elongation to decrease to 50% of the non-stretched film is longer than 85 hours and 95 hours or shorter
D: The time taken for the fracture elongation to decrease to 50% of the non-stretched film is 85 hours or shorter

—Intrinsic Viscosity (IV; Unit: dL/g)—

The polyester A and the polyester B which were used as the raw materials of the polyester film were dissolved in a 1,1,2,2-tetrachloroethane/phenol (=2/3 [mass ratio]) solvent mixture, and the intrinsic viscosity was obtained from the solution viscosity at 25° C. in the solvent mixture.

ηsp/C=[η]+K[η]2·C

Here, ηsp=(solution viscosity/solvent viscosity)−1, C represents the mass of the polymer dissolved in 100 ml of the solvent (set to 1 g/100 ml in the present measurement), and K represents the Huggis constant (set to 0.343). The solution viscosity and the solvent viscosity were respectively measured using an Ostwald viscometer.

—Reflectivity in Visible Light Range—

From the obtained film roll, 10 cm×10 cm films pieces were sampled at a location of the central portion in the width direction of the film and locations 50 cm apart from the central portion in the right and left directions at 0%, 25%, 50%, 75%, and 100% locations in a case in which the start point of the roll winding was considered as 0% and the end point of the winding was considered as 100%. On the total 15 samples, measurements were carried out using a spectrophotometer V-570 manufactured by JASCO Corporation and an integrating sphere ILN-472, the average reflectivity at wavelengths of 400 to 800 nm was obtained, a value obtained by averaging the values of the 15 samples was defined as the reflectivity in the visible light range, and the reflectivity was evaluated according to the following evaluation standards.
A: The reflectivity in the visible light range is more than 90%
B: The reflectivity in the visible light range is more than 85% and 90% or less
C: The reflectivity in the visible light range is more than 80% and 85% or less
D: The reflectivity in the visible light range is 80% or less
C or higher ranks are considered as pass.

—Reflectivity in Near-Infrared Range—

From the obtained film roll, 10 cm×10 cm films pieces were sampled at a location of the central portion in the width direction and locations 50 cm apart from the central portion in the right and left directions at 0%, 25%, 50%, 75%, and 100% locations in a case in which the start point of the roll winding was considered as 0% and the end point of the winding was considered as 100%. On the total 15 samples, measurements were carried out using a spectrophotometer V-570 manufactured by JASCO Corporation and an integrating sphere ILN-472, the average reflectivity at wavelengths of 800 to 2,000 nm was obtained, a value obtained by averaging the values of the 15 samples was defined as the reflectivity in the near-infrared range, and the reflectivity was evaluated according to the following evaluation standards.
A: The reflectivity in the near-infrared range is more than 75%
B: The reflectivity in the near-infrared range is more than 70% and 75% or less
C: The reflectivity in the near-infrared range is more than 65% and 70% or less
D: The reflectivity in the near-infrared range is 65% or less

—Particle Diameters of White Particles in Film Surface Direction—

For the observation of the particle diameters of the white particles dispersed in the film, a scanning electron microscope was used. A torn surface which was parallel to the transportation direction (first direction) of the film and perpendicular to the film surface and a torn surface which was in a direction perpendicular to the transportation direction of the film (second direction) and perpendicular to the film surface were observed in ten different portions of a sample, thereby obtaining observation images of a total of 20 places. Observation was carried out at an appropriate magnification of 100 to 10,000 times, and photographs were captured so that the dispersion state of the white particles could be confirmed in the width of the entire thickness of the film.

The outer circumferences of at least 200 particles randomly selected from the obtained photograph were traced, the lengths of the particles in a direction parallel to the film surface were measured from the traced images using an image analyzer, and these lengths were defined as the particle diameters in the film surface direction. The ratio of the number of agglomerated particles having a particle diameter in the film surface direction of 0.40 to 0.80 to at least 200 measured particles was expressed by a percentage (% by number).

In addition, the primary particle diameters of the white particles present in a primary particle form were also measured in the same manner, thereby obtaining the average primary particle diameter.

### Examples 2 to 8 and Comparative Examples 1 to 12

White polyester films were manufactured in the same manner as in Example 1 except for the fact that film properties and the combinations of manufacturing conditions were changed as shown in Table 1.

Table 1 shows the properties of the films, manufacturing conditions, and evaluations. Meanwhile, in the respective evaluations, A to C were considered as pass.

TABLE 1

| | Film properties | | | | | | | | | |
|---|---|---|---|---|---|---|---|---|---|---|
| | Content of | | Ratio of agglomerated | | | Manufacturing conditions | | | | |
| | white | Average primary | particles having | | | Concentration | | | | |
| | particles | particle of white | particle diameters of | | | of white | | | | Extrusion |
| | % by | particles | 0.40 to 0.80 μm | AV | Thickness | particles in MB | IV_{A} | IV_{B} | IV_{B} − IV_{A} | amount Q |
| | mass | μm | % by number | eq/t | μm | % by mass | dL/g | dL/g | dL/g | kg/h |
| Example 1 | 3.0 | 0.25 | 15 | 20 | 305 | 50 | 0.60 | 0.78 | 0.18 | 2500 |
| Example 2 | 1.0 | 0.25 | 12 | 18 | 305 | 50 | 0.60 | 0.78 | 0.18 | 2500 |
| Example 3 | 5.0 | 0.25 | 16 | 22 | 305 | 50 | 0.60 | 0.78 | 0.18 | 2500 |
| Example 4 | 3.0 | 0.20 | 14 | 20 | 305 | 50 | 0.60 | 0.78 | 0.18 | 2500 |
| Example 5 | 3.0 | 0.38 | 20 | 24 | 305 | 50 | 0.60 | 0.78 | 0.18 | 2500 |
| Example 6 | 3.0 | 0.25 | 10 | 25 | 305 | 50 | 0.60 | 0.78 | 0.18 | 2500 |
| Example 7 | 3.0 | 0.25 | 16 | 20 | 250 | 50 | 0.60 | 0.78 | 0.18 | 2500 |
| Example 8 | 3.0 | 0.25 | 14 | 20 | 305 | 50 | 0.65 | 0.78 | 0.13 | 2500 |
| Comparative | 0.5 | 0.25 | 20 | 17 | 305 | 50 | 0.60 | 0.78 | 0.18 | 2500 |
| Example 1 | | | | | | | | | | |
| Comparative | 6.0 | 0.25 | 18 | 26 | 305 | 50 | 0.60 | 0.78 | 0.18 | 2500 |
| Example 2 | | | | | | | | | | |
| Comparative | 3.0 | 0.10 | 19 | 20 | 305 | 50 | 0.60 | 0.78 | 0.18 | 2500 |
| Example 3 | | | | | | | | | | |
| Comparative | 3.0 | 1.00 | 6 | 31 | 305 | 50 | 0.60 | 0.78 | 0.18 | 2500 |
| Example 4 | | | | | | | | | | |
| Comparative | 3.0 | 0.25 | 7 | 18 | 305 | 50 | 0.78 | 0.78 | 0.00 | 2500 |
| Example 5 | | | | | | | | | | |
| Comparative | 3.0 | 0.25 | 9 | 19 | 305 | 50 | 0.67 | 0.78 | 0.11 | 2500 |
| Example 6 | | | | | | | | | | |
| Comparative | 3.0 | 0.25 | 14 | 31 | 305 | 50 | 0.42 | 0.60 | 0.18 | 2500 |
| Example 7 | | | | | | | | | | |
| Comparative | 3.0 | 0.25 | 11 | 32 | 305 | 50 | 0.60 | 0.78 | 0.18 | 2500 |
| Example 8 | | | | | | | | | | |
| Comparative | 3.0 | 0.25 | 21 | 17 | 305 | 50 | 0.60 | 0.78 | 0.18 | 2500 |
| Example 9 | | | | | | | | | | |
| Comparative | 3.0 | 0.25 | 9 | 24 | 305 | 30 | 0.60 | 0.78 | 0.18 | 2500 |
| Example 10 | | | | | | | | | | |
| Comparative | 3.0 | 0.25 | 22 | 26 | 305 | 70 | 0.60 | 0.78 | 0.18 | 2500 |
| Example 11 | | | | | | | | | | |
| Comparative | 3.0 | 0.25 | 11 | 33 | 305 | 50 | 0.60 | 0.78 | 0.18 | 400 |
| Example 12 | | | | | | | | | | |

| | Manufacturing conditions | | | | | | | |
|---|---|---|---|---|---|---|---|---|
| | Number of | | | Supply | Fluctuation of | Evaluation | | |
| | rotations of | Inner diameter | | amount of | supply amount | | Reflectivity | Reflectivity in |
| | screw N | of cylinder D | | polyester B | of polyester B | Hydrolysis | in visible | near-infrared |
| | min⁻¹ | mm | Q/N/D^{2.8} | kg/h | % | resistance | light range | range |
| Example 1 | 150 | 180 | 8.1E−06 | 2350 | 1.2 | B | B | B |
| Example 2 | 150 | 180 | 8.1E−06 | 2450 | 1.4 | A | C | C |
| Example 3 | 150 | 180 | 8.1E−06 | 2250 | 1.1 | B | A | A |
| Example 4 | 150 | 180 | 8.1E−06 | 2350 | 1.3 | B | B | B |
| Example 5 | 150 | 180 | 8.1E−06 | 2350 | 1.6 | C | B | A |
| Example 6 | 300 | 180 | 4.0E−06 | 2350 | 1.1 | C | A | B |
| Example 7 | 150 | 180 | 8.1E−06 | 2350 | 1.5 | B | B | C |
| Example 8 | 150 | 180 | 8.1E−06 | 2350 | 1.2 | B | B | B |
| Comparative | 150 | 180 | 8.1E−06 | 2475 | 1.2 | A | D | D |
| Example 1 | | | | | | | | |
| Comparative | 150 | 180 | 8.1E−06 | 2200 | 1.3 | D | A | A |
| Example 2 | | | | | | | | |
| Comparative | 150 | 180 | 8.1E−06 | 2350 | 1.1 | B | C | D |
| Example 3 | | | | | | | | |
| Comparative | 150 | 180 | 8.1E−06 | 2350 | 1.2 | D | B | B |
| Example 4 | | | | | | | | |
| Comparative | 150 | 180 | 8.1E−06 | 2350 | 1.2 | A | A | D |
| Example 5 | | | | | | | | |
| Comparative | 150 | 180 | 8.1E−06 | 2350 | 1.1 | A | B | D |
| Example 6 | | | | | | | | |
| Comparative | 150 | 180 | 8.1E−06 | 2350 | 1.3 | D | B | B |
| Example 7 | | | | | | | | |
| Comparative | 450 | 180 | 2.7E−06 | 2350 | 1.2 | D | B | B |
| Example 8 | | | | | | | | |
| Comparative | 125 | 180 | 9.7E−06 | 2350 | 1.1 | A | D | B |
| Example 9 | | | | | | | | |
| Comparative | 150 | 180 | 8.1E−06 | 2350 | 1.1 | B | B | D |
| Example 10 | | | | | | | | |
| Comparative | 150 | 180 | 8.1E−06 | 2350 | 1.3 | C | D | B |
| Example 11 | | | | | | | | |
| Comparative | 24 | 180 | 8.1E−06 | 376 | 1.1 | D | A | B |
| Example 12 | | | | | | | | |

As shown in Table 1, it is found that the white polyester films of the examples are all in a range of A to C in the evaluations of the hydrolysis resistance, the reflectivity in the visible light range, and the reflectivity in the near-infrared range and satisfy both the hydrolysis resistance and the reflectivity of light rays in the visible light range and the near-infrared range. Particularly, in Examples 1, 3, 4, and 8 in which the ratios of the agglomerated particles having particles diameters of 0.40 to 0.80 μm were 14% to 16% by number and the thicknesses of the films were in a range of 280 to 500 μm, it is found that the evaluations of the hydrolysis resistance, the reflectivity in the visible light range, and the reflectivity in the near-infrared range were all B or higher, and the white polyester films were particularly well-balanced white polyester films.

The disclosure of Japanese Patent Application No. 2015-074352 filed on Mar. 31, 2015 is all incorporated into the present specification by reference.

All of publications, patents, patent applications, and technical standards described in the present specification are incorporated into the present specification by reference as much as a case in which the respective publications, patents, patent applications, and technical standards are specifically and respectively incorporated by reference.

What is claimed is:

1. A white polyester film comprising:
a polyester; and
white particles having an average primary particle diameter of 0.20 to 0.40 μm,
wherein, a content of the white particles is from 1.0% to 5.0% by mass with respect to the total mass of the film,
when a cross-section of the film in a thickness direction is observed, a ratio of agglomerated particles having particle diameters of from 0.40 to 0.80 μm in a direction parallel to a surface direction of the film on the cross-section of the film, to a total number of primary particles and agglomerated particles of the white particles dispersed in the film, is from 10% to 20% by number, and
a concentration of terminal carboxyl groups is 6 to 30 equivalents/ton.

2. The white polyester film according to claim 1,
wherein a ratio of white particles having primary particle diameters of less than 0.20 μm is 3% by number or less, and a ratio of white particles having primary particle diameters of more than 0.40 μm is 2% by number or less with respect to the total number of the primary particles and agglomerated particles of the white particle in the white polyester film.

3. The white polyester film according to claim 1,
wherein the white particles comprise titanium dioxide particles, the titanium dioxide particles comprising a rutile-type titanium dioxide of more than 50% by mass with respect to all of the titanium dioxide particles.

4. The white polyester film according to claim 2,
wherein the white particles comprise titanium dioxide particles, the titanium dioxide particles comprising a rutile-type titanium dioxide of more than 50% by mass with respect to all of the titanium dioxide particles.

5. The white polyester film according to claim 1,
wherein the polyester film is a polyethylene terephtharate (PET) film.

6. The white polyester film according to claim 4,
wherein the polyester film is a polyethylene terephtharate (PET) film.

7. The white polyester film according to claim 1,
wherein a thickness thereof is 280 to 500 μm.

8. The white polyester film according to claim 6,
wherein a thickness thereof is 280 to 500 μm.

9. A method for manufacturing the white polyester film according to claim 1,
the white polyester film being formed with a polyester A and a polyester B, wherein an intrinsic viscosity IV_{A} of the polyester A and an intrinsic viscosity IV_{B} of the polyester B satisfy Expressions (I) and (II),
the method comprising:
a master batch preparation step of preparing a master batch including the polyester A and 40% to 60% by mass of white particles having an average primary particle diameter of 0.20 to 0.40 μm with respect to a total mass of the master batch;
an extrusion step of forming a non-stretched film by supplying the master batch and the polyester B to an extruder and melting and extruding a molten resin on a cooling roll while controlling the number of rotations N per minute of a screw in the extruder, an extrusion amount Q of the molten resin from an outlet of the extruder per hour, and an inner diameter D of a cylinder in the extruder to satisfy Expression (III); and
a stretching step of stretching the non-stretched film in at least one direction,
IV_{A}+0.12<IV_{B} (I)
IV_{B}>0.74 (II)
3.0×10⁻⁶×D^{2.8}<Q/N<9.0×10⁻⁶×D^{2.8} (III)
a unit of N is min⁻¹, a unit of Q is kg/h, a unit of D is mm, and units of IV_{A} and IV_{B} are all dL/g.

10. The method or manufacturing a white polyester film according to claim 9,
wherein a thickness of the white polyester film is 280 to 500 μm.

11. The method for manufacturing a white polyester film according to claim 9,
wherein, in the extrusion step, the master batch and the polyester B are supplied to the extruder using mutually different suppliers, and the polyester B is supplied to the extruder by imparting a fluctuation of ±1.0% to ±5.0% of an average supply amount per unit time of supply amounts of the polyester B.

12. The method for manufacturing a white polyester film according to claim 10,
wherein, in the extrusion step, the master batch and the polyester B are supplied to the extruder using mutually different suppliers, and the polyester B is supplied to the extruder by imparting a fluctuation of ±1.0% to ±5.0% of an average supply amount per unit time of supply amounts of the polyester B.

13. The method for manufacturing a white polyester film according to claim 9,
wherein, in the extrusion step, the polyester B is supplied to the extruder in a supply amount of 500 to 5,000 kg/h.

14. The method for manufacturing a white polyester film according to claim 12,
wherein, in the extrusion step, the polyester B is supplied to the extruder in a supply amount of 500 to 5,000 kg/h.

15. A solar cell back sheet comprising:
the white polyester film according to claim 1.

16. A solar cell back sheet comprising:
the white polyester film according to claim 8.

17. A solar cell module comprising:
a solar cell element;
a sealing material that seals the solar cell element;
a front substrate disposed on an outside of the sealing material on a light-receiving surface side of the solar cell element; and
the solar cell back sheet according to claim 15 disposed on an outside of the sealing material on a side opposite to the light-receiving surface side of the solar cell element.

18. A solar cell module comprising:
a solar cell element;
a sealing material that seals the solar cell element;
a front substrate disposed on an outside of the sealing material on a light-receiving surface side of the solar cell element; and
the solar cell back sheet according to claim 16 disposed on an outside of the sealing material on a side opposite to the light-receiving surface side of the solar cell element.
